(19) United States
(12) Patent Application Publication
(10) Pub. No.: US 2012/0266968 A1
(43) Pub. Date: Oct. 25, 2012

(54) ELEVATOR SYSTEM HAVING A SHAFT-SIDE EXTINGUISHING WATER DRAIN SYSTEM

(76) Inventor: Hanspeter Bloch, Buchrain (CH)

(21) Appl. No.: 13/517,456

(22) PCT Filed: Dec. 17, 2010
(86) PCT No.: PCT/EP10/70131

§ 371 Date: Jun. 20, 2012

(30) Foreign Application Priority Data
Dec. 21, 2009 (EP) 09180225.6

(51) Int. Cl. B66B 11/00; A62C 99/00

(52) U.S. Cl. 137/1; 137/357

(57) ABSTRACT

A drain system, in an elevator system, is an open system wherein extinguishing water penetrating through a shaft door sill having bores meets a catch plate arranged underneath the shaft door sill and can be substantially discharged along at least one shaft wall.

### FIELD

The present invention relates to an elevator installation in which at least one elevator car or at least one car and at least one counterweight are moved in opposite sense in an elevator shaft, wherein the at least one elevator car and the at least one counterweight run along guide rails and are supported by one or more supporting and driving means and driven by way of a drive pulley of a drive unit. The present invention relates to an extinguishing water drain system and particularly to the design of the elevator shaft.

### BACKGROUND

Modern elevator installations or so-called fire service elevators, which are designed additionally for this purpose, have to ensure reliable operation even in the case of fire, on the one hand for evacuation of persons and/or material, which is at risk, from the floors affected by the fire and on the other hand also for the transport of fire service personnel and their extinguishing material. In both cases the use of extinguishing water—whether by means of a sprinkler installation or by the fire service or both—should not have the consequence that the elevator installation or the fire service elevator no longer functions.

This means that the electrical components of the elevator installation must remain dry. Moreover, it has to be ensured that the supporting and driving means do not become so wet that an uncontrollable slip arises between the drive pulley and the supporting and driving means. Slip can arise particularly easily, because the extinguishing water on the one hand can directly have a disadvantageous influence on the coefficients of friction between the drive pulley and the supporting and driving means or can change the viscosity of any lubricant present and on the other hand usually contains soap for improved combating of fire.

The slip occurring between drive pulley and supporting and driving means thus leads to a reduction of traction or even to a complete loss of traction of the elevator installation and—in the case of a significant difference between the weight of the elevator car and the weight of the counterweight—possibly to an uncontrolled travel of the elevator car, which has to be stopped by the safety brake thereof. The faultless functioning of the safety brake or the braking retardation of the brake shoes thereof on the guide rail can, however, in turn be guaranteed only if the brake shoes or the guide rail are not moistened by (soapy) extinguishing water.

All these preconditions make it necessary for the extinguishing water to be drained or collected in controlled manner. The extinguishing water normally penetrates via the shaft doors of the elevator shaft into the latter. International published specification WO 98/22381 A1 discloses an elevator installation with closed drainage system at the shaft doors as well as mechanically positively interengaging flow barriers at the sliding doors of each shaft door. In this way it is sought to keep the elevator shaft free from extinguishing water over its entire height at the outset by means of a closed outflow system. However, it is disadvantageous with this solution that each floor has to be equipped beforehand at high cost with appropriate drain pipes and the said flow barriers.

### SUMMARY

It is an object of the present invention to provide an alternative solution to the protection—particularly of the or each supporting and driving means of the elevator installation—from the extinguishing water, which penetrates into the elevator shaft, with avoidance as far as possible of the above-mentioned disadvantage.

Fulfilment of this object consists in the first instance of arranging an open extinguishing water drain system not at the individual shaft doors, but in the elevator shaft. Open means in this connection that the extinguishing water is merely deflected, guided or fed to the critical points, namely to an extinguishing water drain system according to the invention with open sections at which in turn the extinguishing water can freely drip or flow away.

This basic inventive concept derives from recognition that the extinguishing water does not in principle have to be completely kept away from the elevator shaft, but can also flow away in controlled or guided manner into the elevator shaft. It was observed that extinguishing water which penetrates via the shaft doors into the elevator shaft is only a problem for the or each supporting and driving means to the extent that it drops down and atomises in uncontrolled manner because it impinges on obstacles or also only as a consequence of opposing air resistance.

Moreover, it was observed that a principle cause of the or each supporting and driving means becoming wet is the spraying or atomisation of the extinguishing water when impinging on the roof of the elevator car. Consequently, the open extinguishing water drain system, which is at the car side and which is described in the following, can be freely combined with an extinguishing water drain system at the car side, thus both extinguishing water drain systems can be used in an elevator installation in themselves separately, but also together without any additional inventive measures and thus provide further optimization of the overall drain system.

An extinguishing water drain system at the car side is thus distinguished by at least one drain plate arranged on the roof of the elevator car at an inclination to the horizontal. This drain plate can have one or more drain surfaces at different angles of inclination to the horizontal. The drain plate can also be formed from one or more adjustable roller blinds. The drain surfaces of the drain plate or the adjustable roller blind collect extinguishing water impinging on the roof of the elevator car and conduct it to a side surface of the elevator car or by means of channels to corners of the elevator car. A lip arranged at the side surface or outflow openings arranged at the channels in turn conduct the extinguishing water, which has collected on the roof of the elevator car, preferably to corresponding open intermediate spaces or receiving openings of the open extinguishing water drain system which is at the shaft side and described in the following.

A basic variant of a shaft-side extinguishing water drain system according to the invention in an elevator shaft thus provides an open construction by means of which extinguishing water which has already penetrated into the elevator shaft is collected at the outset.

An extinguishing water collector is provided at the underside of a respective shaft door as a first component of an extinguishing water drain system according to the invention at the shaft side. This extinguishing water collector basically consists of a collector plate which is arranged at the shaft wall below the shaft door at an angle of inclination to the vertical. The extinguishing water can be conducted away by the collector plate substantially along at least one shaft wall. This has the effect that the extinguishing water is largely prevented from wetting the car and, in particular, the supporting and driving means, which in turn permits use of the elevator notwithstanding extinguishing water penetrating into the shaft.

According to a first basic variant of this extinguishing water collector in the form of a collector plate an upper edge, which is at the shaft side, of the collector plate does not extend significantly further inwardly of the shaft than the sill of the shaft door. The sill of the shaft door is furnished with grooves and preferably additionally with bores or passage openings or recesses in the grooves between the groove webs and/or in the groove webs themselves so that the extinguishing water can flow through the shaft door sill with least possible hindrance. It is preferred to dispose the hole pattern of the bores so that more extinguishing water can flow through in the center of the shaft door sill than at the sides.

The extinguishing water collector will thus collect extinguishing water which flows through the shaft door sill. By contrast, extinguishing water which might arrive with pressure and in large quantity at the shaft door could spill over the shaft door sill and penetrate between the shaft door sill and the shaft door or doors or through the vertical gap between the sliding doors of the shaft door. According to the prior art, for example the cited International published specification WO 98/22381 A1 it is sought to prevent that by mechanically positive guides of the sliding doors in the shaft door sill as well as a mechanically positive closure edge of the sliding doors.

Lying within the scope of the disclosure of the present patent application is an optional variant of embodiment of the collector plate which protrudes by the upper edge thereof further into the shaft shaft than the shaft door sill and thus also collects extinguishing water flowing over the shaft door sill. Provision of sealing flow barriers can thus be redundant. However, the thereby-resulting spacing between the elevator car and the shaft door sill can be optionally bridged over by an automatic and motor-driven elevator car sill at the respective shaft door sill. The signal for movement of the elevator car sill up to the sill of the respective shaft door can in that regard be coupled with the opening signal of the shaft door or upstream thereof.

The collector plate can—whether flush with or protruding beyond the shaft door sills—be designed in accordance with the following variants:

a) Single-surface or double-surface with an approximately vertical part surface and an inclined part surface adjoining thereat, wherein the inclined part surfaces has an angle of inclination which can be in range of 10 to 80 degrees, but is preferably 45 degrees.
b) The lower edge, which is fastened to the shaft wall, of the collector plate is so arranged at the shaft wall that an intermediate space remains through which the extinguishing water is passed on exclusively to the shaft wall. The sides of the collector plate each have a respective upwardly drawn side plate so that no extinguishing water issues at the sides.
c) The collector plate is fastened by the lower edge thereof to the shaft wall like the variant under b) at a spacing from the shaft wall, but does not have side plates, so that the collected extinguishing water is conducted away not only through the intermediate space of the shaft wall, but also over the sides, preferably into the corners of the elevator shaft.
d) The lower edge, which is fastened to the shaft wall, of the collector plate is arranged flush with and tightly against the shaft wall. The material from which the collector plate is made is, however, apertured to be grid-like and thus allows throughflow of the collected extinguishing water principally to the shaft wall.
e) The collector plate is fastened flush with and tightly against the shaft wall by its lower edge, which is fastened to the shaft wall, like the variant under d), but does not have a grid structure with recesses, instead two tracks or surfaces in mirror image inclined downwardly approximately from the center of the collector plate. The sides are open and preferably have a spout at outflow openings, which conducts the extinguishing water to the corners of the elevator shaft.

The variants of embodiment of the collector plate which guide the extinguishing water away laterally preferably co-operate with a collector section arranged in the corners of the elevator shaft. This collector section can, in its simplest embodiment, be a sheet metal plate—grid-like or whole—mounted at the corner or, however, also a tube or only a C-shaped quarter-tube or a triangular section or a hose. All of these embodiments preferably have at the top a receiving opening widened in funnel shape. The collector profiles are arranged not continuously over the height of the elevator shaft, but merely as several collector section lengths mounted one below or above the other. In this way an open extinguishing water drain system at the shaft side arises, into which extinguishing water at any shaft door can be conducted, but equally also extinguishing water which is collected by the inclined roof construction of the elevator car.

Those variants of embodiment of the collector plate which conduct the extinguishing water approximately perpendicularly to the shaft wall are preferably combined with a drain plate which is preferably arranged at a door lintel of the next-lower shaft door. This drain plate is basically also arranged at an angle of inclination to the vertical. Analogously to the variants of embodiment of the collector plate arranged thereabove, the drain plate—with the same means or shapes described there—can also conduct the extinguishing water exclusively to the shaft wall or, in this case, to the shaft doors or exclusively to the sides or the collector sections in the corners of the elevator shaft or to both.

In the case of this last-mentioned variant of embodiment with a collector plate and a drain plate arranged thereunder a planar outflow plate improving the outflow of the extinguishing water is preferably arranged at the shaft wall between these two plates. Each outflow plate improves the outflow of the extinguishing water relative to the shaft wall just by its planar surface, but can also have a surface structure required for that purpose and/or be painted with a special paint, for example with a paint with lotus-flower effect, which forms a strongly water-repellent surface.

The collector plate, outflow plate and drain plate are respectively separately made as three individual parts or, however, also as a unitary plate section unifying all three plates, and preferably of sheet metal, but plastics material plates also come into consideration.

An extinguishing water drain system according to the invention at the shaft side or an elevator shaft has optional approximately vertically arranged slots in which approximately vertical cage drain plates, which are correspondingly arranged at the elevator car, as spray protection run in recessed manner so that also extinguishing water can no longer penetrate between a possible gap between the vertical cage drain plate and the opposing shaft wall.

An exemplifying elevator installation has, as an additional, optional technical measure for avoidance of a wet supporting and driving means, a respective stripper which is arranged at the two supporting and driving means sections below the drive pulley. These strippers are made of a flexible plastics material sliding on the surface of the supporting and driving means and completely enclose the cross-sectional circumference of the supporting and driving means. They are preferably oriented downwardly in frusto-conical or funnel-shaped manner so that depending on the respective running direction of the supporting and driving means or upward and downward movement of the elevator car always that supporting and driving means section in upward movement, thus towards the drive pulley, is stripped of extinguishing water adhering thereto.

A further variant of embodiment of an elevator installation provides a collecting device which collects the extinguishing water and when the elevator car moves past a trigger lever is unlatched or opened. This has the advantage that, firstly, the extinguishing water in certain circumstances does not drip in uncontrolled manner from the described plates and that, secondly, it is delivered with a gush—which is better controllable in its direction—to wherever desired. This can take place at a point of the elevator shaft which is additionally designed for receiving and conducting away the extinguishing water gush. The collecting devices is preferably equipped with a sensor which shows when the collecting device is full and travel of the elevator car past the trigger lever should take place.

The described individual features can be combined with one another to form an elevator installation, thus, for example, the different embodiments of the collector plate can be unified and combined with the different embodiments of the collector section and/or with the different embodiments of the drain plate as well as with the different embodiments of the elevator car to form an open extinguishing water drain system according to the invention.

Thus, an open extinguishing water drain system according to the invention is preferably characterized by the following functions:
draining the extinguishing water at the sills of the shaft doors;
collecting the drained extinguishing water by means of a collector plate;
draining or feeding the collected extinguishing water by means of a drain plate into two open collector sections at two corners of the elevator shaft;
draining or feeding extinguishing water, which is collected on the roof of the elevator car, similarly into the two open collecting sections at the two corners of the elevator shaft.

An elevator installation equipped in accordance with the invention brings the following advantages:
extinguishing water penetrating through the shaft doors into the elevator shaft is kept away from the or each supporting and driving means;
a reduction of the need for space of an elevator installation and a simplified capability of assembly by comparison with an elevator installation such as disclosed by the prior art and, for example, the above-cited International publication is achieved;
existing elevator installation, regardless of whether without an engine room or with an engine room, can be retrofitted at any time with an open extinguishing water drain system according to the invention at the shaft side and/or with an extinguishing water drain system at the car side without the elevator shaft or the shaft doors having to be constructionally changed.

### DESCRIPTION OF THE DRAWINGS

The invention is explained in more detail symbolically and by way of example on the basis of figures. The figures are described conjunctively and in general. The same reference numerals signify the same components and reference numerals with different indices indicate functionally equivalent or similar components.

In that case:

FIG. 1 shows a schematic illustration of an exemplifying elevator installation with an elevator shaft with an extinguishing water drain system according to the prior art;

FIG. 2 shows a schematic illustration of a first variant of embodiment of an exemplifying elevator shaft or an exemplifying elevator installation with an extinguishing water drain system according to the invention at the shaft side;

FIG. 3 shows a schematic illustration of a second variant of embodiment of an exemplifying elevator shaft or an exemplifying elevator installation with a further extinguishing water drain system according to the invention at the shaft side;

FIG. 4 shows a schematic illustration of a first variant of embodiment of an exemplifying elevator car with an exemplifying extinguishing water drain system at the car side; and

FIG. 5 shows a schematic illustration of a second variant of embodiment of an exemplifying elevator car with an exemplifying extinguishing water drain system at the car side.

### DETAILED DESCRIPTION

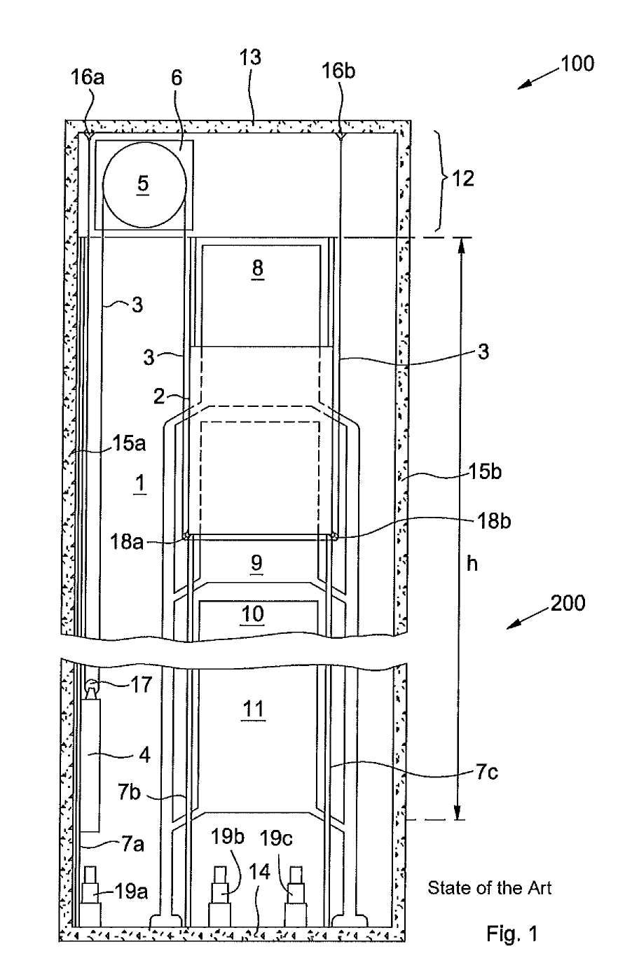

FIG. 1 shows an elevator installation 100 such as is known from the prior art, for example in illustrated 2:1 suspension. An elevator car 2, which is connected with a movable counterweight 4 by way of a supporting and driving means 3, is movably arranged in an elevator shaft 1. The supporting and driving means 3 is, in operation, driven by means of a drive pulley 5 of a drive unit 6, which is arranged in the uppermost region of the elevator shaft 1 in an engine room 12. The elevator car 2 and the counterweight 4 are guided by means of guide rails 7a or 7b and 7c extending over the shaft height.

The elevator car 2 can serve, over a conveying height h, an uppermost floor door 8, further floor doors 9 and 10 and a lowermost floor door 11. The elevator shaft 1 is formed from shaft side walls 15a and 15b, a shaft ceiling 13 and a shaft floor 14, on which a shaft floor buffer 19a for the counterweight 4 and two shaft floor buffers 19b and 19c for the elevator car 2 are arranged.

The supporting and driving means 3 is fastened at a stationary fastening point or support means fixing point 16a to the shaft ceiling 13 and guided parallelly to the shaft side wall 15a to a support roller 17 for the counterweight 4. From here it goes back again over the drive pulley 5 to a first deflecting or support roller 18a and to a second deflecting or support roller 18b, loops under the elevator car 2 and on to a second stationary fastening point or support means fixing point 16b at the elevator shaft 13.

FIG. 1 also symbolically shows a closed extinguishing water drain system 200, which by means of closed pipe ducts and pipe connections conducts extinguishing water away from each individual floor or each individual shaft door 8-11 to the shaft floor 14.

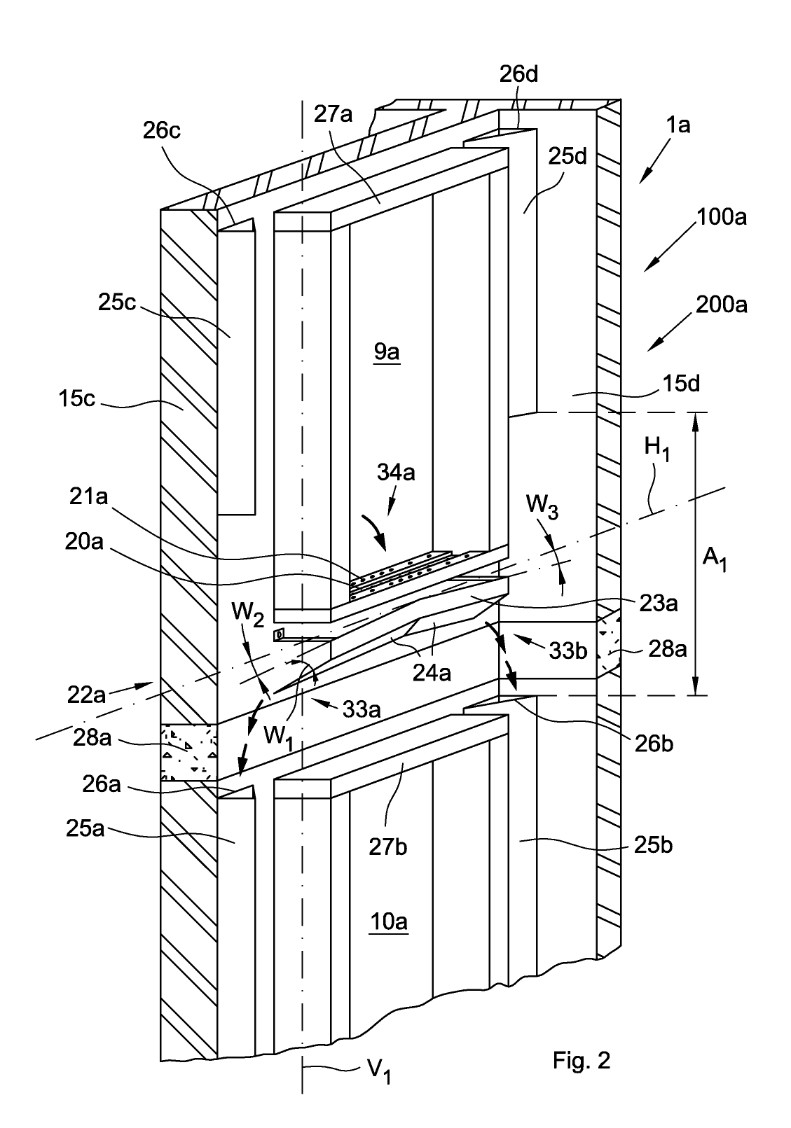

FIG. 2 schematically shows a part of an exemplifying elevator shaft 1a, which is a component of an exemplifying elevator installation 100a. Of the side walls of the elevator shaft 1a, shaft side walls 15c and 15d are illustrated, which are arranged approximately at a right angle to one another. The floors are indicated by a storey floor or screed floor 28a and a respective floor door or shaft door 9a and 10a per floor is illustrated. A respective door lintel 27a and 27b is disposed at the upper side of the shaft doors 9a and 10a. Disposed at the lower side of the shaft door 9a is a shaft door sill 20a which consists of groove webs and has passage openings or recesses or bores 21a preferably not only in the groove webs, but also in the intermediate grooves. The bores 21a in this regard have a hole pattern which is narrower in the center of the shaft door sill 20a and wider towards the sides.

Arranged below the shaft door sill 20a, at the shaft side wall 15c, is a collector plate 22a which forms an approximately vertical—thus parallel to a vertical V₁—part surface 23a and a part surface 24a inclined at an angle of inclination W₁ to the vertical V. At least the inclined part surface 24a or, however, additionally also the approximately vertical part surface 23a forms or form in mirror image approximately from the center of the collector plate 22a a respective angle of inclination W₂ or W₃ to a horizontal H₁.

Consequently, as indicated by arrows, extinguishing water 34a flows through the shaft door sill 20a. The extinguishing water is collected by the collector plate 22a and is fed laterally through respective outflow openings 33a or 33b into receiving openings 26a or 26b respectively of a collector section 25a or 25b. For clarification of an open extinguishing water drain system 200a according to the invention further collector sections 25c and 25d with respective receiving openings 26c and 26d are arranged at a spacing A₁ and serve for reception of extinguishing water which would flow out of a shaft door above the shaft door 9a. The spacing A₁ is on the one hand decisive for reliable transfer of extinguishing water from the higher collector sections 25c and 25d into the lower collector sections 25a and 25b and on the other hand decisive for reliable reception of extinguishing water 34a from the outflow opening 33a and 33b, but also for a reliable reception of extinguishing water which has collected on the roof of the elevator car.

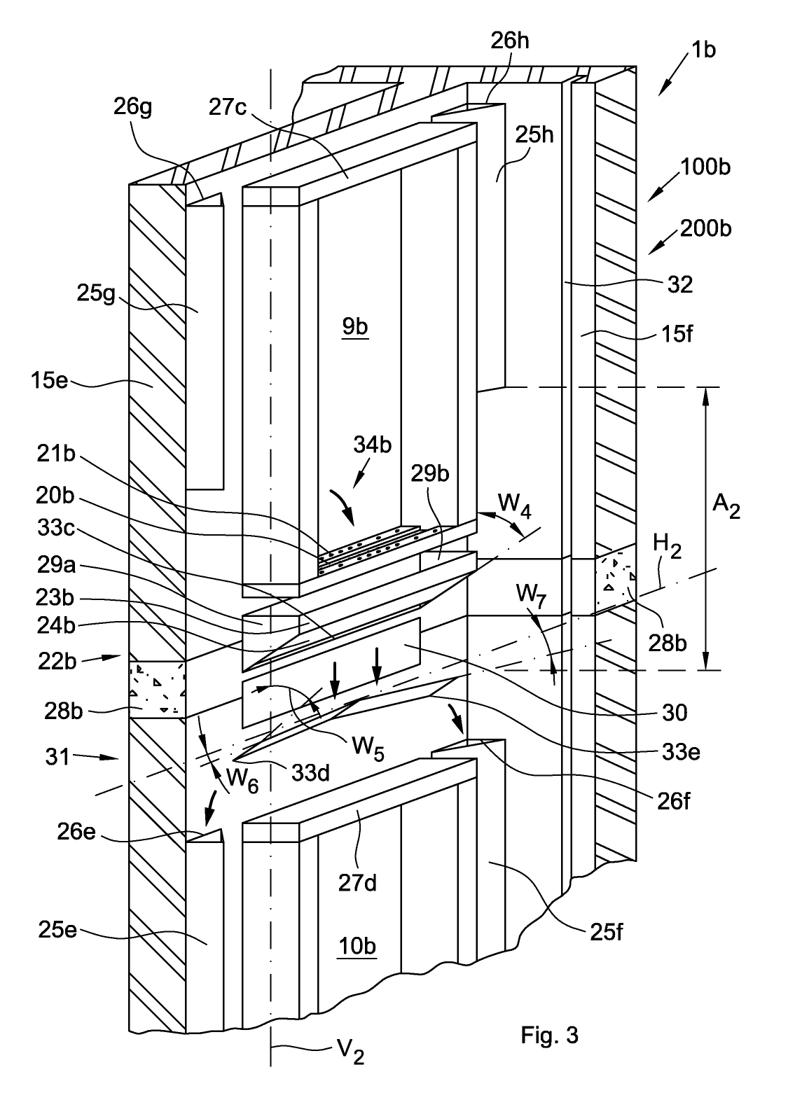

A variant of embodiment of an exemplifying elevator shaft 1b or an exemplifying elevator installation 100b is schematically illustrated in FIG. 3. Analogously to FIG. 2, a shaft door 9b with a door lintel 27c and a shaft door sill 20b with passage openings or recesses or bores 21b and a further shaft door 10b with a door lintel 27d are illustrated in a shaft side wall 15e. A screed floor 28b runs through not only the shaft side wall 15e, but also a further shaft side wall 15f arranged at approximately a right angle.

A collector plate 22b is arranged at the shaft side wall 15e below the shaft door sill 20b. This collector plate 22b is upwardly open and has an approximately perpendicular part surface 23b and an inclined part surface 24b, which adjoins thereat and which has an angle of inclination W₄ to a vertical V₂. The collector plate 22b additionally has side surfaces 29a and 29b. Arranged below the collector plate 22b, similarly at the shaft side wall 15e, is an outflow plate 30 which improves the outflow of extinguishing water 34b which has penetrated through the shaft door sill 20b and which is collected by the collector plate 22b and due to the side surfaces 29a and 29b is conducted onward exclusively centrally through a gap-shaped outflow opening 33c between the inclined part surface 24b and the shaft side wall 15e.

The outflow plate 30 can also be larger than illustrated or connected with the inclined part surface 24b and a drain plate 31 arranged below the outflow plate 30. This drain plate 31 has an angle of inclination W₅ to the vertical V₂ and is additionally inclined downwardly from approximately the center in mirror image with respect to the sides respectively at an angle of inclination W₆ or W₇ to a horizontal H₂ and thus conducts the extinguishing water 34b, which flows away from the outflow plate 30, through respective outflow openings 33d and 33e into a receiving opening 26e of a collector section 25e or a receiving opening 26f of a collector section 25f.

Again, for clarification of an open extinguishing water drain system 200b it is illustrated that further collector sections 25g and 25h with respective receiving openings 26g and 26h are arranged at a spacing A₂ in the corners of the elevator shaft 1b above the collector sections 25e and 25f. Moreover, the elevator shaft 1b has in the shaft side wall 15f a vertically extending slot 32, into which a car drain plate, which is arranged approximately perpendicularly at the elevator car, can run in recessed manner as spray protection.

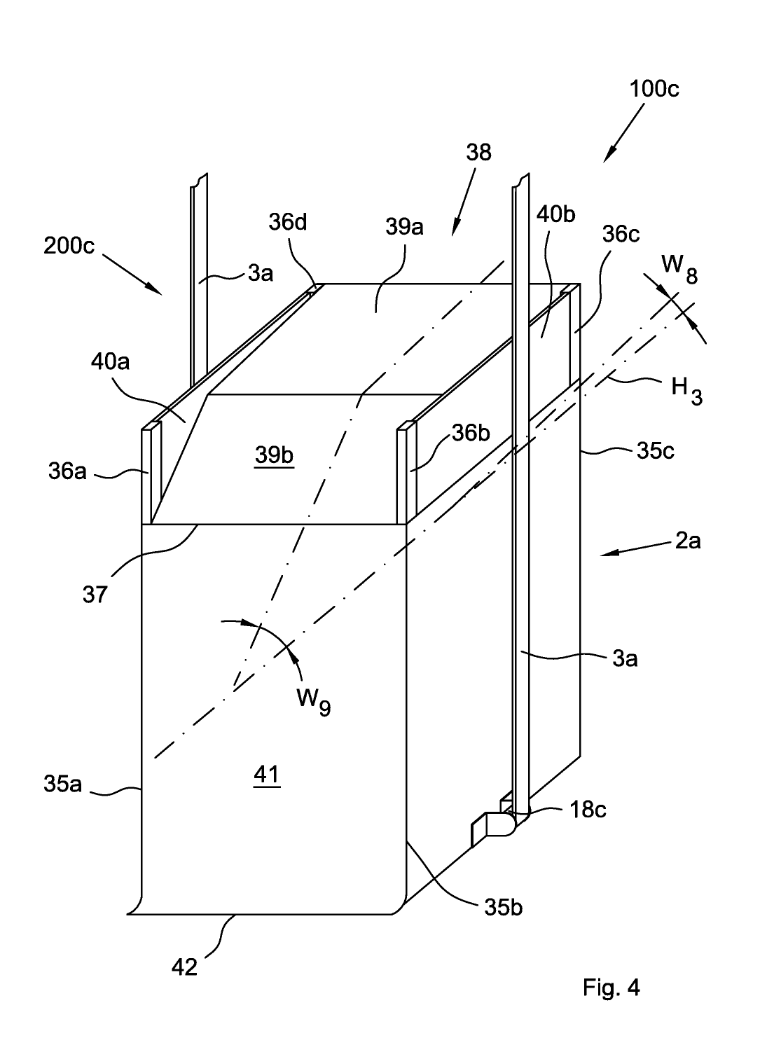

FIG. 4 schematically shows an exemplifying elevator car 2a which is a component of an exemplifying elevator installation 100c. The elevator car 2a is carried by a supporting and driving means 3a which is guided by deflecting or support rollers 18c and 18d, of which in the depicted perspective illustration only the deflecting or support roller 18c is visible. The block-shaped body of the elevator car 2a has four fastening struts 36a-36d in prolongation of four approximately vertical corner edges 35a-35d (of which, due to the perspective view, merely the corner edges 35a-35c are visible).

Fastened to these four fastening struts 36a-36d and flush with an upper edge 37 of the elevator car 2a is rigid and inclined drain plate 38 which forms a first drain surface 39a with an approximate angle of inclination W₈ of 30 degrees to a horizontal H₃ and a second drain surface 39b with an angle of inclination W₉ of approximately 60 degrees to the horizontal H₃. A respective approximately vertically extending connecting plate 40a or 40b is connected with the drain surface 39a or 39b or the fastening struts 36a and 36d or 36b and 36c.

Extinguishing water which has impinged on the drain surfaces 39a and 39b is thus collected and flows down a side surface 41 of the elevator car 2a and is deflected by an optional lip 42. The drain surfaces 39a and 39b, the connecting plates 40a and 40b, the side surface 41 and the lip 42 thus form a first exemplifying elevator car drain system 200c.

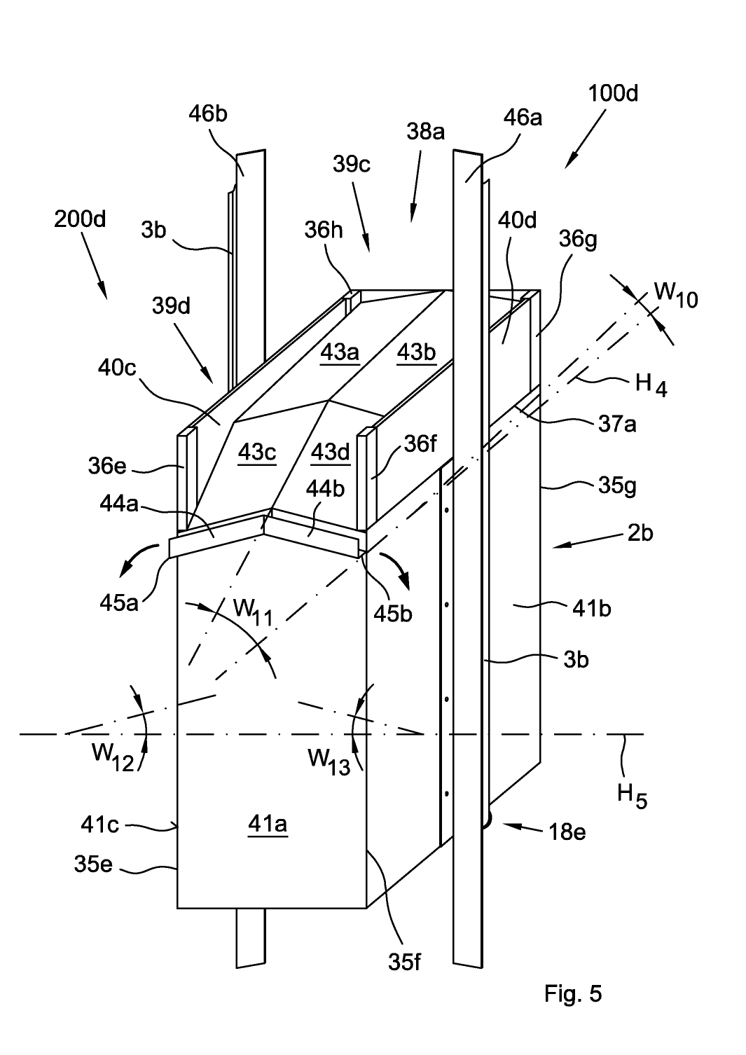

A variant of embodiment of an exemplifying elevator car 2b or an exemplifying elevator installation 100d is schematically illustrated in FIG. 5. The elevator car 2b, supported at a visible deflecting or support roller 18e and at a concealed deflecting or support roller 18f by a supporting and driving means 3b, has between a corner edge 35e and a further corner edge 35f a side surface 41a, between the corner edge 35f and a further corner edge 35g a further side surface 41b and between the corner edge 35e and a corner edge 35h, which is not visible in the illustrated perspective view, a further side surface 41c. The side surfaces 41a, 41b and 41c form an upper edge 37a of the elevator car 2b. Arranged at this upper edge 37a in prolongation of the corner edges 35e-35h are fastening struts 36e-36h at which a drain plate 38a and approximately vertical connecting plates 40c and 40d are fastened.

The drain plate 38a is, analogously to the drain plate 38 of FIG. 4, formed from two drain surfaces 39c and 39d, of which the drain surface 39c is arranged inclined at an angle of inclination W₁₀ of approximately 30 degrees to a first horizontal H₄ and the drain surface 39d is arranged inclined at an angle of inclination W₁₁ of approximately 60 degrees to this first horizontal H₄. The drain surfaces 39c and 39d again respectively form two part surfaces 43a and 43b or 43c and 43d, which are inclined in mirror image and towards the upper edge 37a at a respective angle of inclination W₁₂ and W₁₃ of approximately 30 degrees to a second horizontal H₆.

Two channels 44a and 44b each with a respective outflow or discharge 45a or 45b are arranged at the side surface 41a to be flush with respect to the part surfaces 43c and 43d. In this way the extinguishing water is collected on the roof of the elevator car 2b, conducted away to the side surfaces 41a-41c, collected in the channels 44a and 44b and delivered via the outflows or discharges 45a and 45b at the corner edges 35e and 36f of the elevator car 2b.

For further protection of the supporting and driving means 3b there is arranged at each of the side surfaces 41b and 41c in the form of an angle section a respective vertical drain plate 46a or 46b as spray protection, which can run in recessed manner in the slot 32 of FIG. 3.

The illustrated drain plate 38a, the approximately vertical connecting plates 40c and 40d, the channels 44a and 44b as well as the vertical drain plates 46a and 46b form a second variant of embodiment of an elevator car drain system 200d at the elevator car 2b or in the elevator installation 100d.

It is possible as an optional variant of embodiment to arrange the outflows or discharges 45a and 45b by means of two connecting pipes at the lower edge of the elevator car 2b and in addition optionally feed the extinguishing water, which collects at the vertical drain plates 46a and 46b, to these outflows or discharges 45a and 45b arranged at the lower edge.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A drain system in an elevator installation having an elevator shaft comprising: the drain system being an open system with a collector plate wherein extinguishing water that penetrates through a shaft door sill of the elevator shaft equipped with passage openings impinges on the collector plate arranged below the shaft door sill and is conducted away via outflow openings of the collector plate substantially along at least one shaft wall of the elevator shaft.

17. The drain system according to claim 16 wherein the collector plate has at least one inclined part surface arranged at an angle of inclination to a vertical of the elevator shaft.

18. The drain system according to claim 17 wherein the inclined part surface of the collector plate has a grid structure with recesses.

19. The drain system according to claim 16 wherein the collector plate has at least two part surfaces arranged in mirror image at an angle of inclination to a horizontal of the elevator shaft.

20. The drain system according to claim 16 wherein the extinguishing water is fed through a central outflow opening of the collector plate substantially to a drain plate in the elevator shaft and is conducted away via outflow openings of the drain plate substantially along the at least one shaft wall.

21. The drain system according to claim 20 wherein the drain plate has at least one inclined surface arranged at an angle of inclination to a vertical of the elevator shaft.

22. The drain system according to claim 20 wherein the drain plate has at least two surfaces arranged in mirror image at an angle of inclination to a horizontal of the elevator shaft.

23. The drain system according to claim 20 wherein the drain plate is arranged above a door lintel in the at least one shaft wall of the elevator shaft.

24. The drain system according to claim 20 wherein a planar outflow plate is arranged between the collector plate and the drain plate.

25. The drain system according to claim 16 wherein the extinguishing water is fed via the outflow openings to receiving openings of collector sections arranged at a spacing in a vertical of the elevator shaft.

26. The drain system according to claim 25 wherein the collector sections are triangular shaped sections.

27. The drain system according to claim 25 wherein the collector sections have a receiving opening widened in a funnel shape.

28. An elevator installation with a drain system according to claim 16.

29. A method of draining extinguishing water in an elevator installation with a drain system, comprising the following steps:
a) conducting the extinguishing water through a shaft door sill with bores into an elevator shaft;
b) collecting the extinguishing water with a collector plate in the elevator shaft with at least one part surface inclined at an angle of inclination to a vertical of the elevator shaft;
c) passing on the extinguishing water to at least one outflow opening; and
d) conducting away the extinguishing water from the outflow opening substantially along at least one shaft wall of the elevator shaft.

30. The method according to claim 29 wherein the following steps are performed between the step b) and the step c):
e) allowing the extinguishing water to flow away via a planar outflow plate; and
f) conducting away the extinguishing water via a drain plate with at least one surface inclined at an angle of inclination to the vertical and with at least two surfaces arranged approximately centrally and in mirror image at an angle of inclination to a horizontal of the elevator shaft.
